(19) United States
(12) Patent Application Publication
(10) Pub. No.: US 2004/0003547 A1
(43) Pub. Date: Jan. 8, 2004

(54) Pest barrier with friction tabs for tile roof

(76) Inventor: James H. Beedle, Chandler, AZ (US)

Correspondence Address: SANDRA L. ETHERTON, ETHERTON LAW GROUP, LLC, PO BOX 27843, TEMPE, AZ, 85285-7843, US

(21) Appl. No.: 10/189,979

(22) Filed: Jul. 3, 2002

(51) Int. Cl. E04B 1/72; A01K 3/00; E04H 9/16

(52) U.S. Cl. 52/101

(57) ABSTRACT

A device for preventing pests from nesting inside the openings created by overlapping curved roof tiles. The device is a single piece of wire mesh cut to fit inside the openings and folded such that the tines from the cut edges rub against the inside of the tile. The devices is held in place by friction and requires no fasteners.

### FIELD OF INVENTION

This invention relates to pest-control devices. This invention relates particularly to a barrier for preventing birds from roosting in the openings formed by curved roof tiles, which is held in place without fasteners.

### BACKGROUND

Many homes have roofs made of tiles that are overlapped. Open gaps form under the tiles or between them at the edge of the roof. Birds and other pests build nests and roost in the openings and are problematic. For example, birds are noisy and the bird droppings and feathers they leave are unsightly, messy, and can cause illness. Snakes and rodents that build nests in these openings can be dangerous, especially when disturbed while being removed. It is desirable to prevent pests from roosting in the roof, preferably without harming the animals or the building.

Earlier attempts to solve this problem include a wire mesh used to fill the openings, which is fixed in place with sharp prongs that are driven into the roof. Prior art also includes a scalloped edging, known in the art as birdstop, that is attached to the eave of the house prior to the tiles being laid. The crests of the scallops are supposed to fit within the tiles to close off the openings, but rarely match the actual shape of the openings. Other related prior art devices include wire mesh used on louvers or ventilators to prevent small animals from entering a house. The wire is nailed to the board or siding to close the openings.

A primary disadvantage of prior art barriers is that they are difficult to install because they require some sort of fasteners to attach to the roof or eave. This makes installation more difficult and, in the case of curved roof tiles, can damage the roof.

Therefore, it is an object of this invention to provide an apparatus to prevent pests from gaining access to roof tile openings. It is a further object that the device be easy to install and not damaging to the roof. Another object of this invention is to provide a barrier that is not unsightly.

### SUMMARY OF THE INVENTION

The present invention is a device for preventing pests from nesting inside the openings created by overlapping roof tiles. The device is a single piece of wire mesh cut to fit inside the openings and folded such that the tines from the cut edges rub against the inside of the tile. The devices is held in place by friction and requires no fasteners.

### BRIEF DESCRIPTION OF THE DRAWINGS

FIG. 1 illustrates the present invention installed in an opening of S-shaped roof tiles.

FIG. 2 illustrates the present invention installed in an opening of crescent-shaped roof tiles.

FIG. 3 illustrates the present invention installed in an opening of roofing material having V-shaped openings.

FIG. 4 is a top view of the preferred embodiment of the present invention in its unfolded state.

FIG. 5 is a rear perspective view of the preferred embodiment of the present invention illustrating the folded tabs in the flaps.

FIG. 6 is a top view of a second embodiment of the present invention in its unfolded state.

FIG. 7 is a rear perspective view of the second embodiment of the present invention illustrating the friction tabs in the base.

### DETAILED DESCRIPTION OF THE INVENTION

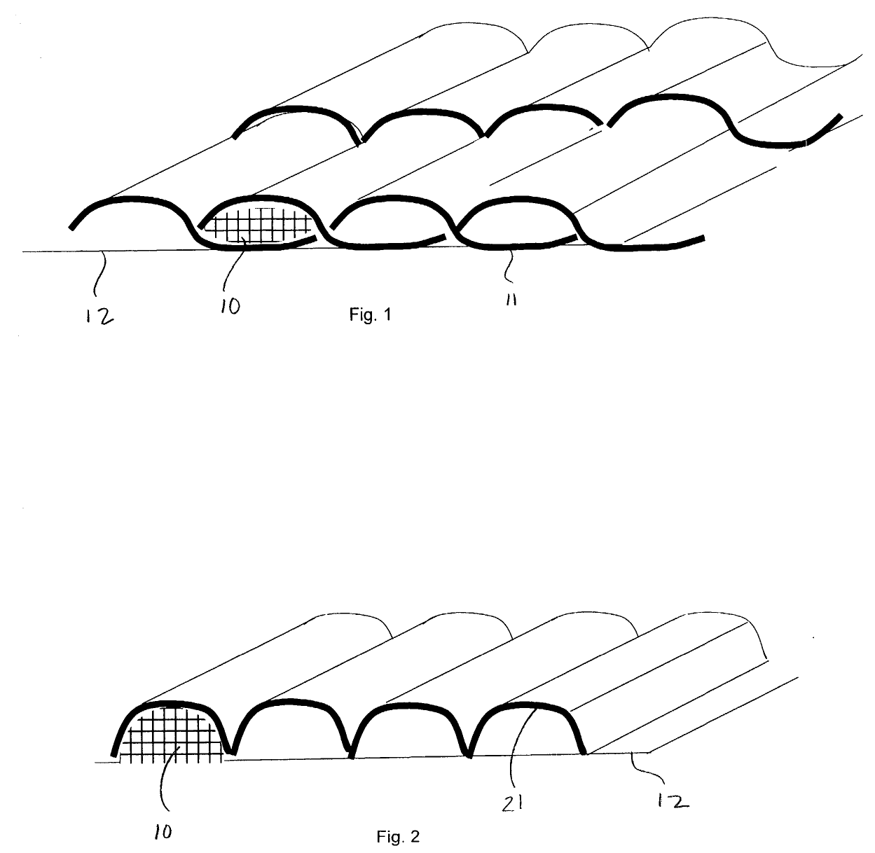

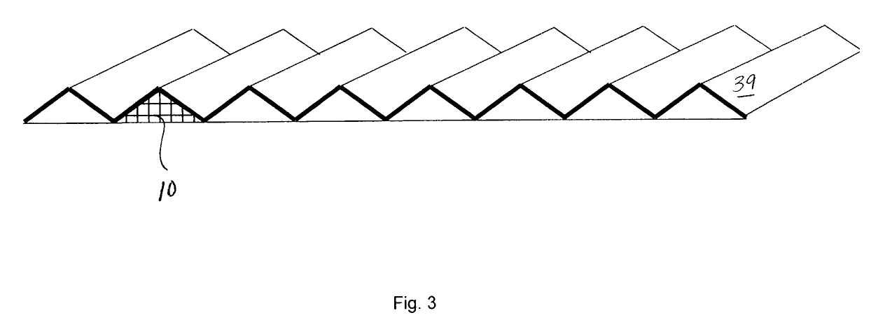

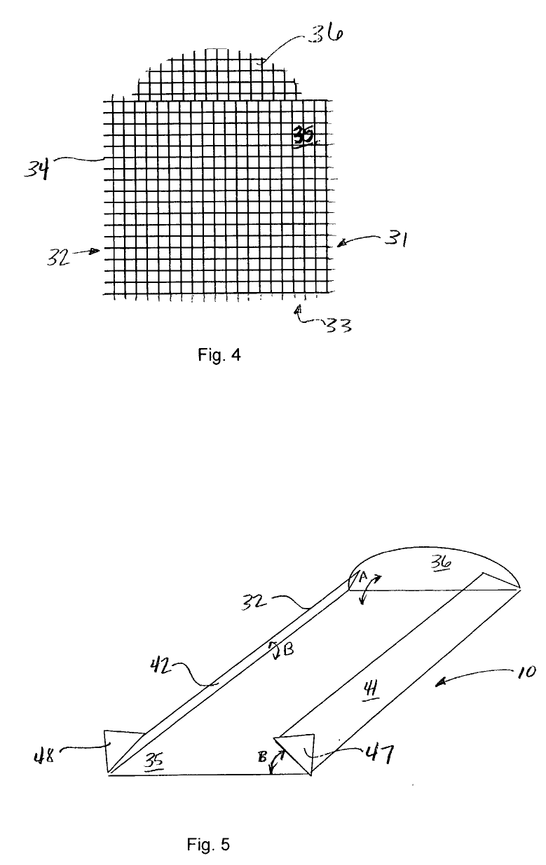

FIGS. 1-7 illustrate the present invention. FIG. 1 shows the pest barrier, referred to generally as 10, installed in an opening formed of overlapping S-shaped tiles 11. FIG. 2 shows the barrier installed in crescent-shaped tiles 21 and FIG. 3 shows the barrier installed in roofing material 39 having v-shaped openings. The barrier of the present invention is a piece of weather-resistant, flexible material which is folded into the configurations shown in FIGS. 5 and 7. FIG. 4 illustrates the preferred embodiment in its unfolded state. The barrier 10 has a rectangular base 35, having first 31, second 32, and third 33 edges. A face 36 extends from and is integral with the base 15. The face 36 is shaped to fit the opening in the tiles well enough to keep birds and other pests from sheltering in the openings. Preferably the edges and face have relatively sharp tines 34 extending therefrom.

FIG. 5 shows the barrier in its folded state as it is used in operation. The face 36 is folded to about a 90 degree angle A to form the barrier that prevents entry into the openings. The angle A will depend on the slope of the roof relative to the tile and the size of the opening. The first edge 31 and second edge 32 are folded to form a first flap 41 and second flap 42, respectively. The flaps are sized such that the resultant width of the barrier is approximately the width of the opening in the tile. Flaps form an angle B of less than 90 degrees so that the barrier can be inserted easily into a tile opening. Tabs are created in the flaps to rub against the inside surface of the tile and thereby create a friction fit. Specifically, the corner of the first flap 41 is folded to form tab 47 and the corner of the second flap 42 is folded to form tab 42. Once inserted, the device cannot be easily removed because the tabs and spiny edges catch on the inside of the tile, which is often uneven in dimension and has a bumpy surface due to many imperfections inherent in ceramic or concrete tiles.

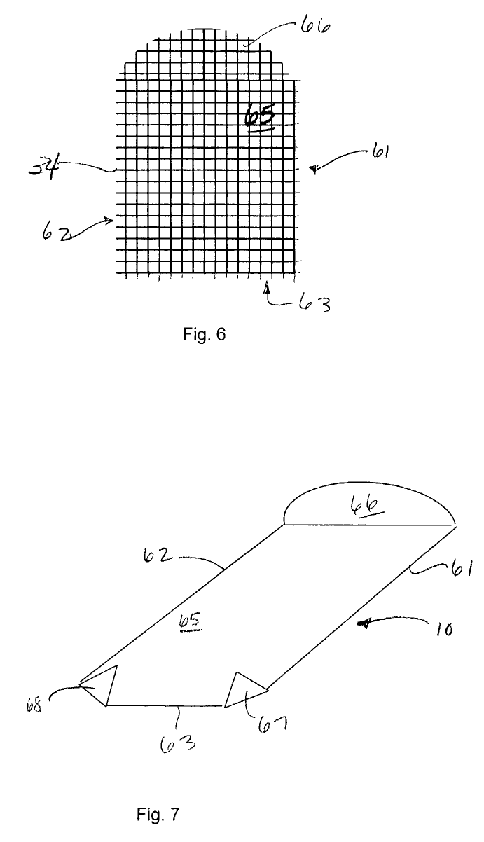

Two versions of the device are contemplated. The second embodiment is shown in FIGS. 6 and 7. FIG. 6 illustrates the second embodiment in its unfolded state. The barrier 10 has a rectangular base 65, having first 61, second 62, and third 63 edges. A face 66 extends from and is integral with the base 65. The face 66 is shaped to fit the opening in the tiles well enough to keep birds and other pests from sheltering in the tile openings. Preferably the edges and face have relatively sharp tines 34 extending therefrom.

FIG. 7 shows the second embodiment in its folded state as it is used in operation. The face 66 is folded to about a 90 degree angle A to form the barrier that prevents entry into the openings. The base 65 is approximately the width of the opening in the tile. Tabs are created in the base to rub against the inside surface of the tile and thereby create a friction fit. Specifically, the corner at the intersection of first edge 61 and third edge 63 is folded to form tab 67. The corner at the intersection of second edge 62 and third edge 63 is folded to form tab 68.

Preferably the device is made of galvanized wire mesh, but any weather-resistant material that retains its folded shape is acceptable. Alternate materials include molded or flexible plastic, rubber, or coated wire mesh. The barrier is preferably a single piece of wire mesh or screen, but may also be made of pieces assembled together. Preferably the material has apertures large enough to allow air and water to pass through the barrier, but not pests, although the barrier may also be a solid material without apertures. The device works in conjunction with all roofing materials that form openings, including tiles of ceramic, concrete and other material; or sheets of corrugated material including metal and fiberglass. Furthermore, the device can be installed in other openings such as drains, downspouts, or vents to prevent pests and debris from passing. These openings may have circular, oval, semicircular, rectangular or other shape.

To prevent birds and other pests from entering the openings in roof tile or other openings, the folded device is simply inserted into the opening. The device cannot be easily removed because as the device slides—or is pulled—out of the opening, the tabs catch on the inside of the tile and are pulled into a more upright position, further increasing the friction between the tabs and the inside of the tile. The tines on the edges create additional resistance to removal because they catch and bind on the rough surface of the tiles.

While there has been illustrated and described what is at present considered to be the preferred embodiment of the present invention, it will be understood by those skilled in the art that various changes and modifications may be made, and equivalents may be substituted for elements thereof without departing from the true scope of the invention. Therefore, it is intended that this invention not be limited to the particular embodiment disclosed as the best mode contemplated for carrying out the invention, but that the invention will include all embodiments falling within the scope of the appended claims.

I claim:

1. An article of manufacture for barring an opening comprising:
a) a rectangular base having a first, second, and third edges wherein the first and second edges are opposite each other;
b) a first flap integral with the base along the first edge such that the first flap can be folded to form an angle of less than 90 degrees to the base;
c) a second flap integral with the base along the second edge such that the second flap can be folded to form an angle of less than 90 degrees to the base;
d) a face integral with the base along the third edge such that the face can be folded to form an angle of about 90 degrees to the base.

2. The article according to claim 1 further comprising:
a) a first tab integral with the first flap such that the corner of the first flap can be folded back upon itself at an angle of less than 90 degrees to the first flap; and
b) a second tab integral with the second flap such that the corner of the second flap can be folded back upon itself at an angle of less than 90 degrees to the second flap.

3. The article according to claim 1 wherein:
a) the opening has a shape;
b) the face has a shape; and
c) the shape of the face approximates the shape of the opening.

4. The article according to claim 1 wherein the barrier is comprised of a flexible mesh.

5. The article of claim 4 wherein the mesh is one of plastic, rubber or metal.

6. An article of manufacture for barring pests from an opening comprising:
a) a rectangular base having a first, second, and third edges wherein the first and second edges are opposite each other;
b) a face integral with the base along the third edge such that the face forms an angle of about 90 degrees to the base.
c) a first tab integral with the first edge formed by folding the first edge back upon itself at an angle of less than 90 degrees to the base; and
d) a second tab integral with the second edge formed by folding the second edge back upon itself at an angle of less than 90 degrees to the base.

7. A device for barring for barring birds from openings between curved roof tiles comprising:
a) a rectangular base of wire mesh having a first, second, and third edges wherein the first and second edges are opposite each other and have a plurality of tines;
b) a first flap integral with the base formed by folding the first edge such that the first flap forms an angle of less than 90 degrees to the base;
c) a second flap integral with the base formed by folding the second edge such that the second flap forms an angle of less than 90 degrees to the base;
d) a face having an approximately semicircular shape and integral with the base, the face formed by folding the third edge such that the face forms an angle of about 90 degrees to the base;
e) a first tab in the first flap formed by folding the corner of the first flap back upon itself such that the first tab forms an angle of less than 90 degrees to the first flap; and
f) a second tab in the second flap formed by folding the corner of the second flap back upon itself such that the second tab forms an angle of less than 90 degrees to the second flap;
such that the face substantially fills the opening and the tines of the first and second tabs provide sufficient friction against the opening to hold the device in place.
